(19) United States
(12) Patent Application Publication
(10) Pub. No.: US 2024/0278728 A1
(43) Pub. Date: Aug. 22, 2024

(54) Snowplow Mounting Utility Rack Device

(71) Applicant: David Van Nosdeln, Ohiopyle, PA (US)

(72) Inventor: David Van Nosdeln, Ohiopyle, PA (US)

(21) Appl. No.: 18/357,404

(22) Filed: Jul. 24, 2023

Related U.S. Application Data
(60) Provisional application No. 63/398,297, filed on Aug. 16, 2022.

(51) Int. Cl. B60R 9/06; E01H 5/06

(52) U.S. Cl. CPC B60R 9/065; E01H 5/066

(57) ABSTRACT

The present invention relates to a novel snowplow utility device. The device is designed to fit a snowplow receiver. The device will mount to the snowplow receiver and can be removed for winter storage. The device comprises a carryall rack component and a storage component that is a metal basket constructed of a wire mesh. The storage component would be secured to the lowest point of the carryall rack component and then secured to the two uprights of the rack component frame with fasteners. Further, a pair of hooks would be secured to the two uprights of the rack component to protect the vehicle when the device is secured to the plow receiver.

### CROSS-REFERENCE TO RELATED APPLICATION

The present application claims priority to, and the benefit of, U.S. Provisional Application No. 63/398,297, which was filed on Aug. 16, 2022, and is incorporated herein by reference in its entirety.

### FIELD OF THE INVENTION

The present invention relates generally to the field of snowplow utility devices. More specifically, the present invention relates to an improved snowplow utility device that provides users with a carryall rack designed to fit on a snowplow receiver. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in snowplow utility devices. Climbing into the back of a truck for tools can be frustrating and unsafe, especially if the process is constantly repeated. Further, truck beds may lack enough space for other items if several tools are stored in the truck bed.

Furthermore, plow receivers on a truck often remain idle other than being used in the wintertime. When not in use, plow receivers can be used to mount additional storage components for storing various tools and accessories. If the tools and accessories are secured and then mounted to the plow receiver, the vehicle can be a useful place to store the tools and accessories.

Thus, it is necessary for users to have extra room to store tools and accessories, without having to climb into the back of a truck or other vehicle with a plow. Further, users need an area that can store additional tools when the bed of a truck is full. There is also a need for easy access to the tools and other accessories within the vehicle.

Therefore, there exists a long-felt need in the art for a snowplow utility device that provides users with a carryall rack designed to fit on a snowplow receiver. There is also a long-felt need in the art for a snowplow utility device that allows users to easily attach and remove the receiver for winter storage. Further, there is a long-felt need in the art for a snowplow utility device that features a basket-like bottom structure to store and organize tools. Moreover, there is a long-felt need in the art for a device that maintains easy access to items for different jobs without having to constantly climb in and out of a truck bed. Further, there is a long-felt need in the art for a snowplow utility device that saves extensive time and effort when working with a snowplow truck. Finally, there is a long-felt need in the art for a snowplow utility device that users can apply to a plow receiver with ease and store when not in use.

The subject matter disclosed and claimed herein, in one embodiment thereof, comprises a snowplow utility device. The device is designed to fit a snowplow receiver. The device will mount to the snowplow receiver and can be removed for winter storage. The device comprises a carryall rack component and a storage component that is a metal basket constructed of a wire mesh. The storage component would be secured to the lowest point of the carryall rack component and then secured to the two uprights of the rack component frame, such that the storage component would have tracks on the metal basket, allowing the storage component to slide onto the uprights of the rack component in a sandwich style and then be secured with fasteners. Thus, creating three sections, left, right, and center for the storage component. Further, a pair of hooks would be secured to the two uprights of the rack component to protect the vehicle finish and/or the vehicle when the device is secured to the plow receiver.

In this manner, the snowplow utility device of the present invention accomplishes all of the foregoing objectives and provides users with a device that maintains easy access to items for different jobs without having to constantly climb in and out of a truck bed. The device provides users with a carryall rack designed to fit on a snowplow receiver for storing tools. The device fits most snowplow receivers and saves extensive time and effort when working with a snowplow truck.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a snowplow utility device. The device is designed to secure to a snowplow receiver. The device will mount to the snowplow receiver and can be removed for winter storage. The device comprises a carryall rack component and a storage component that is a metal basket constructed of a wire mesh. The storage component would be secured to the lowest point of the carryall rack component and then secured to the two uprights of the rack component frame.

In one embodiment, the snowplow utility device comprises a carryall rack component. The rack component can be any suitable rack as is known in the art and can be any suitable shape and size as is known in the art. Typically, the rack component comprises a pair of uprights in a spaced apart configuration. However, any suitable number of uprights can be utilized as is known in the art, depending on the needs and/or wants of a user. The pair of uprights are generally linear in shape and then extend to a curved or rounded shape. Specifically, the pair of uprights extend from a vertical position to a horizontal position. The pair of uprights are secured in place via at least one horizontal member.

In one embodiment, there are three horizontal members with one positioned at the top of the pair of uprights, one positioned at the bottom of the pair of uprights, and one positioned near the middle of the pair of uprights. The one positioned near the middle allows the storage component to rest against it when in position secured to the plow receiver. However, any number of horizontal members can be utilized as is known in the art, depending on the needs and/or wants of a user.

In one embodiment, the pair of uprights and the at least one horizontal member are manufactured from heat-scalable plastic or polymers, such as polypropylene or acrylonitrile-butadiene-styrene (ABS), or durable metals, or wood, or any other suitable material as is known in the art. Typically, the pair of uprights and the at least one horizontal member are secured together via any suitable fasteners as is known in the art, such as screws, bolts, welding, adhesives, gluing, etc.

In another embodiment, a pair of hooks or holders can be secured to the outside sides of the pair of uprights, typically near the top of the uprights. The hooks or holders can be any suitable shape and size, as long as they act to prevent the rack component from damaging the vehicle or vehicle finish. In one embodiment, the hooks or holders can be manufactured of metal and stamped or welded into the uprights for use. In another embodiment, the hooks or holders can be manufactured of fiberglass or plastic and secured to the uprights via adhesives, gluing, etc.

In one embodiment, the snowplow utility device comprises a storage component. The storage component can be any suitable size and shape as is known in the art, as long as the storage component can retain various tools and accessories of different shapes and sizes. Typically, the storage component is shaped as a metal basket, comprising a bottom, front, and rear opposing sides, and left and right opposing sides, and an open top area. The open top area allows a user to place various sizes and shapes of tools and accessories within the storage component. In one embodiment, the open top area can comprise a lid secured to the rear opposing side via hinges or other fasteners. The hinges allow the lid to open and close. Further, the lid can also comprise a latch or other locking mechanism to secure the contents of the storage component.

Generally, the storage component is a metal basket manufactured of wire mesh with a weather resistant coating, but the storage component can be manufactured of any suitable material as is known in the art, such as heat-scalable plastic or polymers, such as polypropylene or acrylonitrile-butadiene-styrene (ABS), etc.

In another embodiment, the storage component is secured to the rack component. Typically, the storage component would slide onto the horizontal parts of the pair of uprights of the rack component. In one embodiment, the storage component would comprise tracks or grooves that accept the horizontal parts of the pair of uprights of the rack component. This allows the storage component to slide onto the pair of uprights in a sandwich style and be secured with fasteners. Once in place on the rack component uprights, the storage component is segmented into three sections, a left container, a middle container, and a right container via placement of the uprights. Any suitable number of sections can be formed for the storage component, depending on the number of uprights used in the rack component, and depending on the needs and/or wants of a user. Further, the storage component is secured to the rack component via any suitable fasteners as is known in the art, such as gluing, adhesives, screws, bolts, etc.

In another embodiment, the storage component comprises a plurality of fastening straps for retaining the contents. The fastening straps can be any suitable strap as is known in the art, such as a Velcro strap, an elastic strap, a buckle strap, etc. The straps act to secure the contents of the storage component during transport.

In another embodiment, the snowplow utility device comprises a plurality of lights that aid a user in finding tools and accessories within the storage component.

In another embodiment, the snowplow utility device comprises a winch or other towing device.

In yet another embodiment, the snowplow utility device comprises a plurality of indicia.

In yet another embodiment, a method of storing tools within a vehicle is described. The method includes the steps of providing a snowplow utility device comprising a rack component and a storage component that includes a metal basket. The storage component is secured to the frame of the rack component during use. The method also comprises mounting the snowplow utility device on a plow receiver. Further, the method comprises placing tools and other accessories within the metal basket of the storage component. The method also comprises securing the tools and other accessories within the storage component via fasteners. Finally, utilizing the vehicle while carrying the tools and accessories within the device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the snowplow utility device of the present invention disclosing the storage component in accordance with the disclosed architecture;

FIG. 2 illustrates a perspective view of one embodiment of the snowplow utility device of the present invention disclosing the carryall rack component in accordance with the disclosed architecture;

FIG. 3 illustrates a perspective view of the snowplow utility device of the present invention in use in accordance with the disclosed architecture; and

FIG. 4 illustrates a flowchart showing the method of storing tools within a plow receiver when the receiver is not in use in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a snowplow utility device that provides users with a carryall rack designed to fit on a snowplow receiver. There is also a long-felt need in the art for a snowplow utility device that allows users to easily attach and remove the receiver for winter storage. Further, there is a long-felt need in the art for a snowplow utility device that features a basket-like bottom structure to store and organize tools. Moreover, there is a long-felt need in the art for a device that maintains easy access to items for different jobs without having to constantly climb in and out of a truck bed. Further, there is a long-felt need in the art for a snowplow utility device that saves extensive time and effort when working with a snowplow truck. Finally, there is a long-felt need in the art for a snowplow utility device that users can apply to a plow receiver with ease and store when not in use.

The present invention, in one exemplary embodiment, is a novel snowplow utility device. The device is designed to fit a snowplow receiver. The device will mount to the snowplow receiver and can be removed for winter storage. The device comprises a carryall rack component and a storage component that is a metal basket constructed of a wire mesh. The storage component would be secured to the lowest point of the carryall rack component and then secured to the two uprights of the rack component frame. Further, a pair of hooks would be secured to the two uprights of the rack component to protect the plow receiver and/or the vehicle when the device is secured to the plow receiver. The present invention also includes a novel method of storing tools within a vehicle. The method includes the steps of providing a snowplow utility device comprising a rack component and a storage component that includes a metal basket. The storage component is secured to the frame of the rack component during use. The method also comprises mounting the snowplow utility device on a plow receiver. Further, the method comprises placing tools and other accessories within the metal basket of the storage component. The method also comprises securing the tools and other accessories within the storage component via fasteners. Finally, utilizing the vehicle while carrying the tools and accessories within the device.

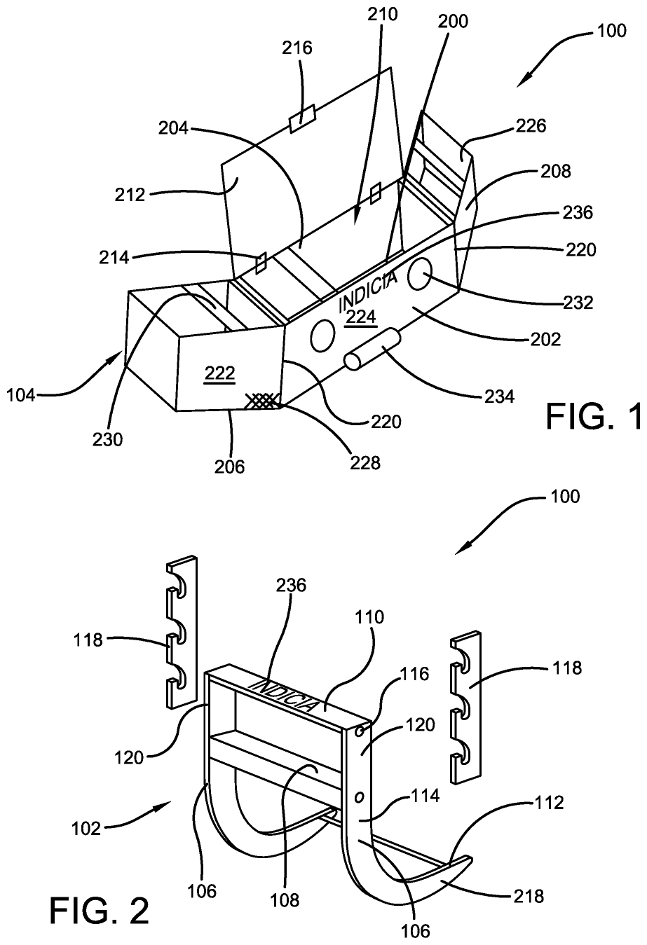

Referring initially to the drawings, FIGS. 1-2 illustrate a perspective view of one embodiment of the snowplow utility device 100 of the present invention. In the present embodiment, the snowplow utility device 100 is an improved snowplow utility device that maintains easy access to items without having to constantly climb in and out of a truck bed. The device 100 will mount to the snowplow receiver and can be removed for winter storage. The snowplow utility device 100 further comprises a carryall rack component 102 (shown in FIG. 2) and a storage component 104 (shown in FIG. 1). The storage component 104 would be secured to the carryall rack component 102 and then the carryall rack component 102 would be secured to a plow receiver. The plow receiver can be any suitable plow receiver as is known in the art, such as a receiver that accepts a snowplow, etc., or other suitable plow.

As shown in FIG. 2, the snowplow utility device 100 comprises a carryall rack component 102. The rack component 102 can be any suitable rack as is known in the art and can be any suitable shape and size as is known in the art. Typically, the rack component 102 comprises a pair of uprights 106 in a spaced apart configuration. However, any suitable number of uprights 106 can be utilized as is known in the art, depending on the needs and/or wants of a user. The pair of uprights 106 are generally linear in shape and then extend to a curved or rounded shape. Specifically, the pair of uprights 106 extend from a vertical position to a horizontal position. The pair of uprights 106 are secured in place via at least one horizontal member 108.

In one embodiment, there are three horizontal members 108 with one positioned at the top 110 of the pair of uprights 106, one positioned at the bottom 112 of the pair of uprights 106, and one positioned near the middle 114 of the pair of uprights 106. The one positioned near the middle 114, allows the storage component 104 to rest against it when in position and secured to the rack component 102. However, any number of horizontal members 108 can be utilized as is known in the art, depending on the needs and/or wants of a user.

Furthermore, the pair of uprights 106 and the at least one horizontal member 108 are manufactured from heat-scalable plastic or polymers, such as polypropylene or acrylonitrile-butadiene-styrene (ABS), or durable metals, or wood, or any other suitable material as is known in the art, such as but not limited to, acrylic, polycarbonate, polyethylene, thermoplastics, polyethylene terephthalate, polyvinyl chloride, polystyrene, etc. Generally, the rack component 102 is also manufactured from a material that is water resistant or water permeable, or the uprights 106 and horizontal members 108 comprise a coating that is water resistant or water permeable. Additionally, the pair of uprights 106 and the at least one horizontal member 108 are secured together via any suitable fasteners 116 as is known in the art, such as screws, bolts, welding, adhesives, gluing, etc.

Further, a pair of hooks or holders 118 can be secured to the outside sides 120 of the pair of uprights 106, typically near the top 110 of the uprights 106. The hooks or holders 120 can be any suitable shape and size, as long as they act to protect the vehicle and prevent the rack component 102 from damaging the vehicle's finish when secured within the plow receiver. In one embodiment, the hooks or holders 118 can be manufactured of metal and stamped or welded into the uprights 106 for use. In another embodiment, the hooks or holders 118 can be manufactured of fiberglass or plastic and secured to the uprights 106 via adhesives, gluing, etc.

As shown in FIG. 1, the snowplow utility device 100 comprises a storage component 104. The storage component 104 can be any suitable size and shape as is known in the art, as long as the storage component 104 can retain various tools and accessories of different shapes and sizes. Typically, the storage component 104 is shaped as a metal basket, comprising a bottom 200, front 202 and rear 204 opposing sides, and left 206 and right 208 opposing sides, and an open top area 210. The open top area 210 allows a user to place various sizes and shapes of tools and accessories within the storage component 104. In one embodiment, the open top area 210 can comprise a lid 212, secured to the rear opposing side 204 via hinges 214 or other fasteners. The hinges 214 allow the lid 212 to open and close. Further, the lid 212 can also comprise a latch 216 or other locking mechanism to secure the contents of the storage component 104.

Furthermore, the storage component 104 is a metal basket manufactured of wire mesh with a weather resistant coating, but the storage component 104 can be manufactured of any suitable material as is known in the art, such as heat-scalable plastic or polymers, such as polypropylene or acrylonitrile-butadiene-styrene (ABS), or durable metals, or any other suitable material as is known in the art, such as but not limited to, acrylic, polycarbonate, polyethylene, thermoplastics, polyethylene terephthalate, polyvinyl chloride, polystyrene, etc. Generally, the storage component 104 is also manufactured from a material that is water resistant or water permeable, or the storage component 104 comprises a coating that is water resistant or water permeable.

Additionally, the storage component 104 is secured to the rack component 102. Typically, the storage component 104 would slide onto the horizontal parts 218 of the pair of uprights 106 of the rack component 102. In one embodiment, the storage component 104 would comprise tracks or grooves 220 that accept the horizontal parts 218 of the pair of uprights 106 of the rack component 102. This allows the storage component 104 to slide onto the pair of uprights 106 in a sandwich style and be secured with fasteners. Once in place on the rack component 102 uprights 106, the storage component 104 is segmented into three sections, a left container 222, a middle container 224, and a right container 226 via placement of the uprights 106. Any suitable number of sections can be formed for the storage component 104, depending on the number of uprights 106 used in the rack component 102, and depending on the needs and/or wants of a user. Further, the storage component 104 is secured to the rack component 102 via any suitable fasteners 228 as is known in the art, such as gluing, adhesives, screws, bolts, etc.

In another embodiment, the storage component 104 comprises a plurality of fastening straps 230 for retaining the contents. The fastening straps 230 can be any suitable strap as is known in the art, such as a Velcro strap, an elastic strap, a buckle strap, etc. The fastening straps 230 act to secure the contents of the storage component 104 during transport. The fastening straps 230 can be any suitable size and shape as is known in the art, depending on the needs and/or wants of a user. Further, any suitable number of fastening straps 230 can be utilized as is known in the art, depending on the needs and/or wants of a user. In the embodiment, where the storage component 104 comprises a lid 212, the fastening straps 230 would be unnecessary, but could still be utilized if the user so desires.

In another embodiment, the snowplow utility device 100 comprises a plurality of lights 232 that aid a user in finding tools and accessories within the storage component 104. The plurality of lights 232 can be any suitable lights as is known in the art, such as LEDs, incandescent, halogen, etc. Any number of lights 232 can be utilized as is known in the art, depending on the needs and/or wants of a user. The plurality of lights 232 can be secured to any suitable part of the snowplow utility device 100 via any suitable fasteners as is known in the art, such as adhesives, Velcro, gluing, etc.

In another embodiment, the snowplow utility device 100 comprises a winch 234 or other towing device. The winch 234 can be secured to any suitable part of the snowplow utility device 100, depending on the needs and/or wants of a user. The winch 234 can be secured via any suitable fasteners as is known in the art, such as bolts, screws, welding, adhesives, etc. Any suitable winch 234 or towing device can be utilized as is known in the art.

Additionally, the snowplow utility device 100 comprises a plurality of indicia 236. The rack component 102 and storage component 104 may include advertising, a trademark, or other letters, designs, or characters, printed, painted, stamped, or integrated into the device 100, or any other indicia 236 as is known in the art. Specifically, any suitable indicia 236 as is known in the art can be included, such as but not limited to, patterns, logos, emblems, images, symbols, designs, letters, words, characters, animals, advertisements, brands, etc., that may or may not be vehicle or plow/brand related.

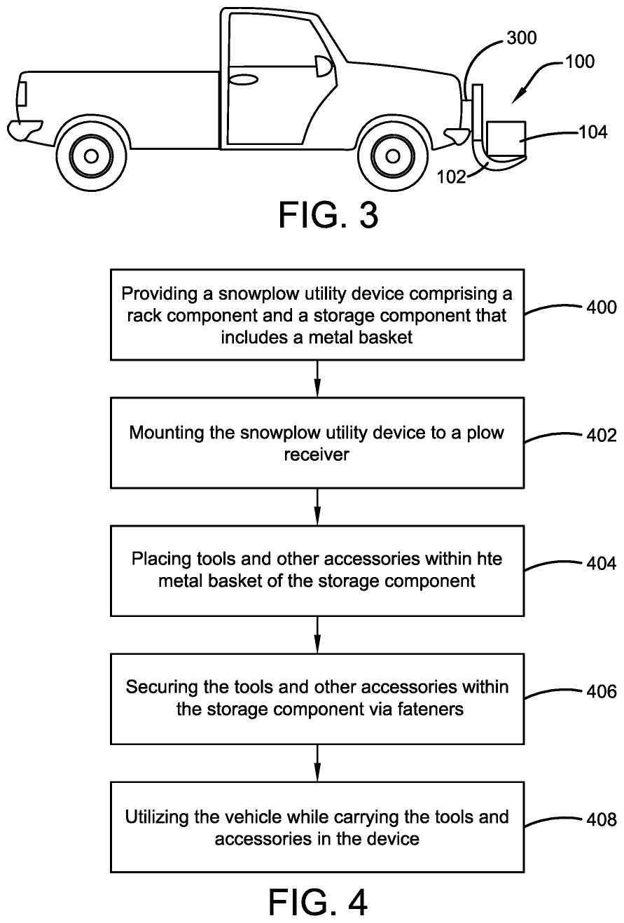

As shown in FIG. 3, in use, the snowplow utility device 100 is mounted directly to a plow receiver 300. The storage component 104 of the device 100 can then be filled with multiple tools and accessories of various sizes and shapes. The storage component 104 can then be slid onto the rack component 102 of the device 100 and secured. Once in position, the device 100 is mounted to the plow receiver 300. The contents of the storage component 104 can then be secured with a lid or additional straps.

FIG. 4 illustrates a flowchart of the method of storing tools within a vehicle. The method includes the steps of at 400, providing a snowplow utility device comprising a rack component and a storage component that includes a metal basket. The storage component is secured to the frame of the rack component during use. The method also comprises at 402, mounting the snowplow utility device on a plow receiver. Further, the method comprises at 404, placing tools and other accessories within the metal basket of the storage component. The method also comprises at 406, securing the tools and other accessories within the storage component via fasteners. Finally, at 408, utilizing the vehicle while carrying the tools and accessories within the device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “snowplow utility device”, “plow device”, and “device” are interchangeable and refer to the snowplow utility device 100 of the present invention.

Notwithstanding the foregoing, the snowplow utility device 100 of the present invention can be of any suitable size and configuration as is known in the art without affecting the overall concept of the invention, provided that it accomplishes the above-stated objectives. One of ordinary skill in the art will appreciate that the snowplow utility device 100 as shown in FIGS. 1-3 are for illustrative purposes only, and that many other sizes and shapes of the snowplow utility device 100 are well within the scope of the present disclosure. Although the dimensions of the snowplow utility device 100 are important design parameters for user convenience, the snowplow utility device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A snowplow utility device for maintaining easy access to items without having to climb in and out of a truck bed, the snowplow utility device comprising:
a rack component; and
a storage component; and
wherein the storage component is secured to the rack component;
wherein the rack component is then mounted to a plow receiver; and
further wherein tools can be secured within the storage component for ease of transportation.

2. The snowplow utility device of claim 1, wherein the rack component comprises a pair of uprights in a spaced apart configuration.

3. The snowplow utility device of claim 2, wherein at least one horizontal member is secured across the pair of uprights.

4. The snowplow utility device of claim 3, wherein the pair of uprights are generally linear in shape and then extend to a curved shape.

5. The snowplow utility device of claim 4, wherein a hook is secured to an outside side of each pair of uprights to prevent the snowplow utility device from damaging a vehicle.

6. The snowplow utility device of claim 5, wherein the storage component comprises a bottom, front and rear opposing sides, and left and right opposing sides, and an open top area.

7. The snowplow utility device of claim 6, wherein the open top area comprises a lid with hinges and a latch.

8. The snowplow utility device of claim 7, wherein the storage component comprises tracks to allow the storage component to slide easily on the rack component.

9. The snowplow utility device of claim 8, wherein the storage component would slide onto the pair of uprights of the rack component.

10. The snowplow utility device of claim 9, wherein once in place on the rack component uprights, the storage component is segmented into sections.

11. The snowplow utility device of claim 10, wherein the storage component is segmented into a left container, a middle container, and a right container via placement of the pair of uprights.

12. The snowplow utility device of claim 11, wherein the storage component comprises a plurality of fastening straps for retaining contents of the storage component.

13. A snowplow utility device for maintaining easy access to items without having to climb in and out of a truck bed, the snowplow utility device comprising:
a rack component comprising a pair of uprights in a spaced apart configuration, with at least one horizontal member secured across the pair of uprights; and
a storage component comprising a bottom, front and rear opposing sides, and left and right opposing sides, and an open top area; and
wherein the pair of uprights are generally linear in shape and then extend to a curved shape;
wherein the storage component comprises tracks to allow the storage component to slide easily on the rack component;
wherein the storage component would slide onto the pair of uprights of the rack component;
wherein once in place on the rack component uprights, the storage component is segmented into three sections; and
further wherein the rack component is then mounted to a plow receiver.

14. The snowplow utility device of claim 13 further comprising a plurality of lights on the storage component.

15. The snowplow utility device of claim 13 further comprising a winch secured to the storage component or the rack component.

16. The snowplow utility device of claim 13 further comprising a plurality of indicia.

17. The snowplow utility device of claim 13, wherein the storage component comprises a plurality of fastening straps for retaining contents of the storage component.

18. The snowplow utility device of claim 13, wherein the open top area comprises a lid with hinges and a latch.

19. The snowplow utility device of claim 13 wherein a hook is secured to an outside side of each pair of uprights to prevent the snowplow utility device from damaging a vehicle.

20. A method of storing tools within a vehicle, the method comprising the steps of:
providing a snowplow utility device comprising a rack component and a storage component that includes a metal basket;
mounting the snowplow utility device to a plow receiver;
placing tools and other accessories within the metal basket of the storage component;
securing the tools and other accessories within the storage component via fasteners; and
utilizing the vehicle while carrying the tools and accessories in the device.
